(19) United States
(12) Patent Application Publication
(10) Pub. No.: US 2017/0123441 A1
(43) Pub. Date: May 4, 2017

(54) THERMOSTAT PROXIMITY SENSOR

(71) Applicant: Lennox Industries Inc., Richardson, TX (US)

(72) Inventor: STEVE CHARLES LAZAR, San Antonio, TX (US)

(21) Appl. No.: 14/925,647

(22) Filed: Oct. 28, 2015

(51) Int. Cl. G05D 23/19; G05B 15/02; F24F 11/02

(52) U.S. Cl. CPC G05D 23/1917; F24F 11/02; G05B 15/02

(57) ABSTRACT

A heating, ventilation, and air conditioning (HVAC) device that includes a transmitter configured to generate a transmission signal. A splitter is operably coupled to the transmitter and is configured to output the transmission signal to an antenna and output a reflected signal to a microprocessor. The HVAC device also includes a memory that is operable to store at least a baseline frequency threshold for a room. The microprocessor is operably coupled to the transmitter, the splitter, the memory, and is configured to determine a frequency difference between the frequency of the transmission signal and the frequency of the reflected signal, compare the frequency difference to the baseline frequency threshold, determine that an object is moving when the frequency difference is greater than the baseline frequency threshold, and output a first control signal to adjust a temperature if the object is determined to be moving.

### TECHNICAL FIELD

This disclosure relates generally to heating, ventilating, and air conditioning (HVAC) systems, and more specifically to system and method for detecting objects.

### BACKGROUND

Existing thermostat proximity sensors used in heating, ventilation, and air conditioning (HVAC) systems may use either infrared (IR) sensors or cameras to detect the presence of a moving object in a room. IR sensors are limited due to their limited detection range and their need of large lenses to extend their detection range. The use of cameras or visual detection may be limited due to privacy concerns. It is desirable to provide an HVAC device that improves the functionality of a thermostat without affecting privacy.

### SUMMARY

In one embodiment, the disclosure includes a heating, ventilation, and air conditioning (HVAC) device that comprises a transmitter configured to generate a transmission signal. A splitter is operably coupled to the transmitter and is configured to output the transmission signal to an antenna and output a reflected signal to a microprocessor. The HVAC device further comprises a memory that is operable to store at least a baseline frequency threshold for a room. The microprocessor is operably coupled to the transmitter, the splitter, the memory, and is configured to determine a frequency difference between the frequency of the transmission signal and the frequency of the reflected signal, compare the frequency difference to the baseline frequency threshold, determine that an object is moving when the frequency difference is greater than the baseline frequency threshold, and output a first control signal to adjust a temperature if the object is determined to be moving.

In another embodiment, the disclosure includes an HVAC detection method comprising transmitting a transmission signal and receiving a reflected signal in response to transmitting the transmission signal. The method further comprises comparing the amplitude of the reflected signal to a baseline amplitude threshold to determine whether an object is present and determining a frequency difference between the frequency of the transmission signal and the frequency of the reflected signal if the object is determined to be present. The method further comprises comparing the frequency difference to a baseline frequency threshold,

determining that the object is moving when the frequency difference is greater than the baseline frequency threshold, and output a first control signal to adjust a temperature if the object is determined to be moving.

In yet another embodiment, the disclosure includes an HVAC device that comprises a transmitter configured to generate a pulsed transmission signal. A splitter is operably coupled to the transmitter and is configured to output the pulsed transmission signal to an antenna and output a reflected signal to a microprocessor. The HVAC further comprises a memory operable to store at least a baseline distance threshold for a room. The microprocessor is operably coupled to the transmitter, the splitter, the memory, and configured to determine a time difference between when the pulsed transmission signal is transmitted and when the reflected signal is received, determine a distance using the time difference, compare the distance to the baseline distance threshold to determine whether an object is within a distance range, and output a first control signal to activate a display if the object is determined to be within the distance range.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a heating, ventilation, and air conditioning (HVAC) device;

FIG. 2 is a schematic diagram of an embodiment of an HVAC system implementing zoning using an HVAC device;

FIG. 3 is a flowchart of an embodiment of a proximity detection method for an HVAC device;

FIG. 4 is a flowchart of another embodiment of a proximity detection method for an HVAC device;

FIG. 5 is a flowchart of another embodiment of a proximity detection method for an HVAC device; and

FIG. 6 is a flowchart of another embodiment of a proximity detection method for an HVAC device.

### DETAILED DESCRIPTION OF THE DRAWINGS

Disclosed herein are various embodiments for implementing object detection for HVAC systems. In an embodiment, an HVAC device (e.g. a thermostat) is configured to detect the presence of an object, to detect whether an object is moving, and/or to determine the distance of the object from the HVAC device. Additionally, the HVAC device may be in signal communication with a centralized controller and configured to provide zoning functionality for an HVAC system.

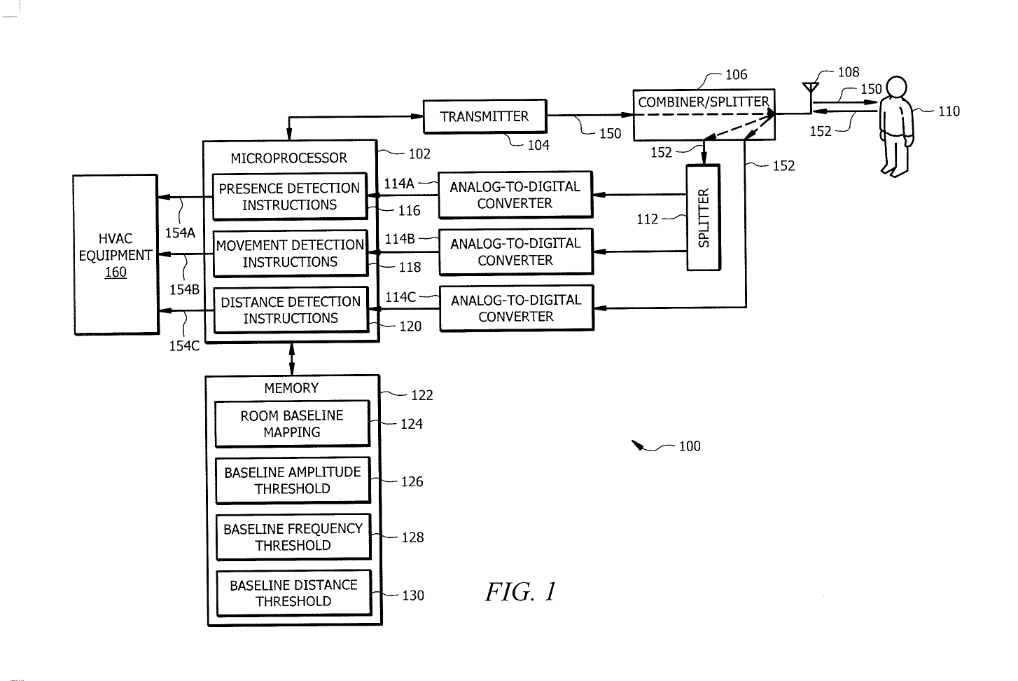

FIG. 1 is a schematic diagram of an embodiment of an HVAC apparatus or device 100. The HVAC device 100 is configured to detect the presence of an object (e.g. a person) 110, detect whether the object 110 is moving, and/or determine the distance of the object 110 from the HVAC device 100. The HVAC device 100 is configured to output control signals that indicate whether an object is present, an object is moving, and/or an object is within a predefined distance range of the HVAC device 100. The control signals may be used by HVAC equipment 160 to control the temperature within in a room or to activate a display, for example, a display on the

HVAC device 100.

In an embodiment, the HVAC device 100 is or is incorporated within a thermostat for an HVAC system. In another embodiment, the HVAC device 100 may be incorporated within HVAC equipment 160. For example, the HVAC device 100 may be incorporated within a heater, an air conditioner, a compressor, a blower, a vent, a duct, or any other HVAC equipment as would be appreciated by one of ordinary skill in the art upon viewing this disclosure. The HVAC device 100 comprises a microprocessor 102, a memory 122, a transmitter 104, a combiner/splitter 106, a splitter 112, an antenna 108, a first analog-to-digital converter (ADC) 114A, a second ADC 114B, and a third ADC 114C. The HVAC device 100 is operably coupled to and in signal communication with HVAC equipment 160. Examples of HVAC equipment 160 include, but are not limited to, a heater, an air conditioner, a compressor, a blower, a vent, and a duct. The HVAC device 100 and the HVAC equipment 160 may be operably coupled to each other via a wireless or a wired connection. The HVAC equipment 160 is configured to receive control signals 154A, 154B, and 154C from the HVAC device 100 and to use the control signals 154A-154C to control the temperature within in a room or to activate a display (not shown). The control signals 154A-154C may be used to activate (e.g. turn on) the HVAC equipment 160. For example, the control signals 154A-154C may be used to turn on an air condition or a heater in response to detecting an object. The HVAC device 100 may be configured as shown or in any other suitable configuration.

Examples of transmitter 104 include, but are not limited to, a surface acoustic wave (SAW) oscillator and a pulsed transistor switch. The transmitter 104 is operably coupled to the microprocessor 102 and the combiner/splitter 106. The transmitter 104 is configured to generate a transmission signal or a pulsed transmission signal 150 and to output the transmission signal or the pulsed transmission signal 150 to the combiner/splitter 106. In an embodiment, the transmission signal is an oscillating signal and the pulsed transmission signal is a digital pulse wave signal. As an example, the transmission signal may be a signal between about 10 gigahertz (GHz) and about 20 GHz with about 1 milliwatt (mW) of power output. The transmitter 104 may also be configured to receive control signals from the microprocessor 102, for example, to activate or deactivate the transmitter 104.

An example of a combiner/splitter 106 includes, but is not limited to, a branch microstrip coupler. The combiner/splitter 106 is operably coupled to the transmitter 104, the splitter 106, the third ADC 114C, and to the antenna 108. The combiner/splitter 106 is configured to output a transmission signal 150 toward the antenna 108 and to output a reflected signal 152 toward the microprocessor 102. The combiner/splitter 106 is configured to provide a first path from the transmitter 104 to the antenna 108 for a transmission signal 150 and a second path from the antenna 108 to the splitter 106 and the third ADC 114C for a reflected signal 152. In an alternative embodiment, the combiner/splitter 106 may be directly connected to the first ADC 114A or the second ADC 114B and configured to provide the second path between the antenna 108 and the first ADC 114A and the second ADC 114B for the reflected signal 152.

An example of the antenna 108 includes, but is not limited to, patch microstrip antennas. The antenna 108 is operably coupled to the combiner/splitter 106. The antenna 108 is configured to transmit the transmission signal or a pulsed transmission signal 150 and to receive a reflected signal 152 in response to transmitting the transmission signal or the pulsed transmission signal 150. The received reflected signal 152 may be an attenuated representation of the transmission signal 150 when an object 110 is present and may have a different frequency than the transmission signal 150 when the object 110 is moving. In an embodiment, the antenna 108 may be configured with a vertical polarization and a horizontal polarization. For example, the horizontal polarization may be used for determining an object's location or movement with respect to a horizontal plane and the vertical polarization may be used for determining the object's location or movement with respect to a vertical plane.

An example of the splitter 112 includes, but is not limited to, a radio frequency (RF) signal splitter. The splitter 112 is operably coupled to the combiner/splitter 106, the first ADC 114A, and the second ADC 114B. The splitter 112 is configured to communicate the reflected signal 152 from the combiner/splitter 106 to the first ADC 114A and the second ADC 114B. The splitter 112 may be configured to output the reflected signal 152 to any number of devices that are coupled the splitter 112.

The first ADC 114A, the second ADC 114B, and the third ADC 114C are each configured to convert an analog reflected signal to a digital reflected signal. The first ADC 114A is operably coupled to the splitter 112 and the microprocessor 102 and is configured to receive an analog reflected signal from the splitter 112 and to output a digital reflected signal to the microprocessor 102. The second ADC 114B is operably coupled to the splitter 112 and the microprocessor 102 and is configured to receive an analog reflected signal from the splitter 112 and to output a digital reflected signal to the microprocessor 102. The third ADC 114C is operably coupled to the combiner/splitter 106 and the microprocessor 102 and is configured to receive an analog reflected signal from the combiner/splitter 106 and to output a digital reflected signal to the microprocessor 102. In an alternative embodiment, the first ADC 114A and/or the second ADC 114B may be directly coupled to the combiner/splitter 106.

The microprocessor 102 may be implemented as one or more central processing unit (CPU) chips, logic units, cores (e.g. as a multi-core processor), field-programmable gate arrays (FPGAs), application specific integrated circuits (ASICs), or digital signal processors (DSPs). The microprocessor 102 is operably coupled to and in signal communication with the transmitter 104, the memory 122, the first ADC 114A, the second ADC 114B, the third ADC 114C, and the HVAC equipment 160. The microprocessor 102 may also be operably coupled to one or more other devices (e.g. a display) (not shown). The microprocessor 102 is configured to process data (e.g. digital reflected signals) and may be implemented in hardware and software.

In FIG. 1, the presence detection instructions 116, the movement detection instructions 118, and the distance detection instructions 120 are implemented as instructions (e.g. software code or firmware) stored in the microprocessor 102. Alternatively, the presence detection instructions 116, the movement detection instructions 118, and/or the distance detection instructions 120 may be implemented as instructions stored in the memory 122. The inclusion of the presence detection instructions 116, the movement detection instructions 118, and the distance detection instructions 120 provides an improvement to the functionality of the HVAC device 100, which effects a transformation of the HVAC device 100 to a different state.

Presence detection instructions 116 are implemented by microprocessor 102 to execute instructions for detecting the presence of an object using an amplitude difference between a transmission signal 150 and a reflected signal 152 and outputting a control signal 154A for controlling a temperature for the room when an object is present. For example, the presence detection instructions 116 may be configured to determine that an object is present when the amplitude of the reflected signal 152 is below a baseline amplitude threshold 126 for the room or when the difference between the amplitude of the transmission signal 150 and the amplitude of the reflect signal 152 is greater than a baseline amplitude threshold 126 for the room. The presence detection instructions 116 may output the control signal 154A to the HVAC equipment 160 when an object is present.

Movement detection instructions 118 are implemented by microprocessor 102 to execute instructions for detecting when an object is moving using a frequency difference (e.g. a Doppler shift) between the frequency of the transmission signal 150 and the frequency of the reflected signal 152 and outputting a control signal 154B for controlling a temperature for the room when an object is moving. For example, the movement detection instructions 118 is configured to determine that an object is moving towards or away from the HVAC device 100 based on whether there is a frequency difference between the frequency of the reflected signal 152 and the frequency of the transmission signal 150. The movement detection instructions 118 may determine that an object is moving when the difference between the transmission signal 150 and the reflected signal 152 is greater than a baseline frequency threshold 128 for the room and may output the control signal 154B to the HVAC equipment 160 when the object is moving.

Distance detection instructions 120 are implemented by microprocessor 102 to execute instructions for determining the distance of an object from the HVAC device 100 using a pulsed transmission signal 150 and outputting a control signal 154C to activate a display when the object is within a distance range. For example, the distance detection instructions 120 is configured to use a time difference between when the pulsed transmission signal 150 is transmitted and when the reflected signal 152 is received to determine a distance the object is away from the HVAC device 100 and to compare the distance to a baseline distance threshold 130 to determine whether the object is within a predefined distance range. The distance detection instructions 120 may output the control signal 154C to the HVAC equipment 160 when the object is within a predetermined distance range.

The memory 122 may comprise one or more disks, tape drivers, or solid-state drives and may be used as an over-flow data storage device, to store programs when such programs are selected for execution, and to store instructions and data that are read during program execution. The memory 122 may be volatile or non-volatile and may comprise read-only memory (ROM), random-access memory (RAM), ternary content-addressable memory (TCAM), dynamic random-access memory (DRAM), and static random-access memory (SRAM). Memory 122 is operable to store a room baseline mapping 124 that comprises one or more baseline thresholds for a room or baseline values based on a topology of a room. The baseline values may be obtained and stored for a predefined topology of a room and may be used to establish the baseline thresholds for the room. The baseline thresholds may comprise a baseline amplitude threshold 126, a baseline frequency threshold 128, and a baseline distance threshold 130. The baseline thresholds are used for distinguishing objects in a room.

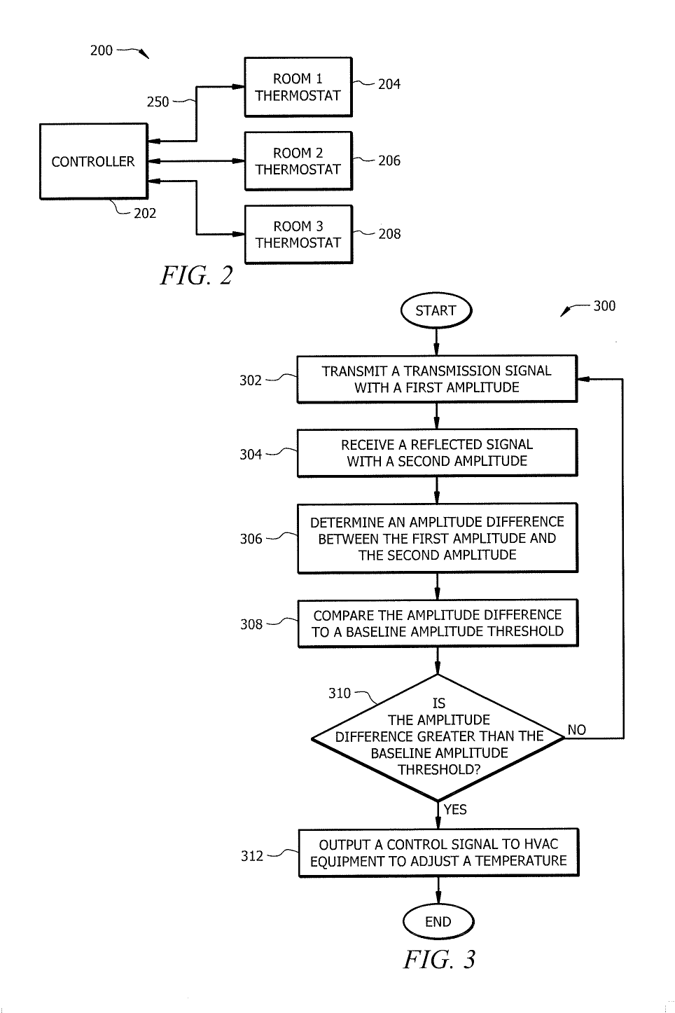

FIG. 2 is a schematic diagram of an embodiment of an HVAC system 200 implementing zoning using an HVAC device. Zoning may allow a centralized controller to control the temperature of a plurality of rooms based on control signals (e.g. control signals 154A-154C in FIG. 1) provided by HVAC devices 204, 206, and 208 within the rooms. The HVAC system 200 comprises a controller 202 in signal communication with the HVAC devices 204-208. The HVAC devices 204-208 may each be configured similarly to HVAC device 100 in FIG. 1. In an embodiment, the HVAC devices 204-208 are each configured as or incorporated within a thermostat for a room. For example, HVAC device 204 may be incorporated in a first thermostat in a first room, HVAC device 206 may be incorporated in a second thermostat for a second room, and HVAC device 208 may be incorporated in a third thermostat for a third room. The HVAC devices 204-208 are configured to output control signals that indicate whether an object is present, an object is moving, and/or an object is within a predefined distance range of the HVAC device. The controller 202 is configured to communicate with the HVAC devices 204-208 via wireless or hardwired links. The controller 202 may also be in signal communication with one or more other pieces of HVAC equipment (not shown) such as compressors, vents, and ducts. The controller 202 is configured to receive control signals from the HVAC devices 204-208 and to use information from the control signals to control the temperature in one or more rooms. For example, the controller 202 may use the control signals to turn on/off a compressor or to adjust a vent or air duct.

FIG. 3 is a flowchart of an embodiment of a proximity detection method 300 for an HVAC device. Method 300 is implemented by an HVAC device to determine whether an object is present. For example, method 300 may be implemented to control the temperature in a room based on whether an object is present in the room. The HVAC device may be configured similarly to HVAC device 100 in FIG. 1 or HVAC devices 204-208 in FIG. 2. At step 302, the HVAC device transmits a transmission signal with a first amplitude. The transmission signal may be or may be similar to the transmission signal 150 in FIG. 1. At step 304, the HVAC device receives a reflected signal with a second amplitude. The reflected signal may be or may be similar to the reflected signal 152 in FIG. 1. At step 306, the HVAC device determines an amplitude difference between the first amplitude of the transmission signal and the second amplitude of the reflected signal. At step 308, the HVAC device compares the amplitude difference to a baseline amplitude threshold. The baseline amplitude threshold may be or may be similar to the baseline amplitude threshold 126 in FIG. 1. At step 310, the HVAC device proceeds to step 312 when the amplitude difference is greater than the baseline amplitude threshold. Otherwise, the HVAC device returns to step 302 when the amplitude difference is less than the baseline amplitude threshold. At step 312, the HVAC device determines that an object is present and outputs a control signal to HVAC equipment (e.g. HVAC equipment 160 in FIG. 1) to adjust a temperature in response to the determination. The control signal may be or may be similar to the control signal 154A in FIG. 1. For example, the HVAC device may output a control signal to turn on an air conditioner in response to determining that an object is present.

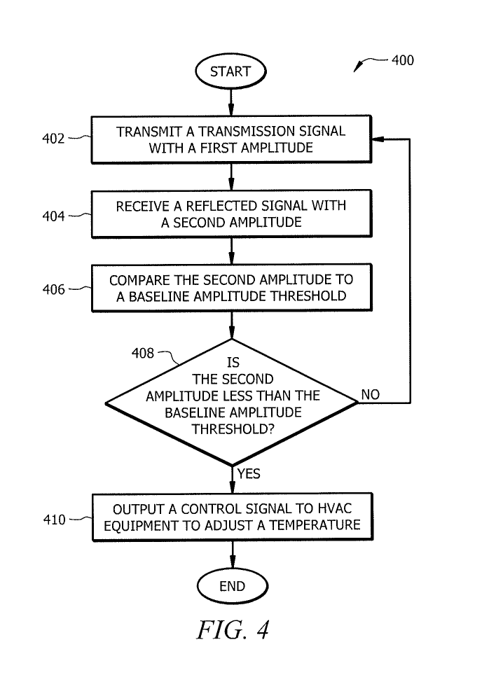

FIG. 4 is a flowchart of an embodiment of a proximity detection method 400 for an HVAC device. Method 400 is implemented by an HVAC device to determine whether an object is present. For example, method 400 may be implemented to control the temperature in a room based on whether an object is present in the room. The HVAC device may be configured similarly to HVAC device 100 in FIG. 1 or HVAC devices 204-208 in FIG. 2. At step 402, the HVAC device transmits a transmission signal with a first amplitude. The transmission signal may be or may be similar to the transmission signal 150 in FIG. 1. At step 404, the HVAC device receives a reflected signal with a second amplitude. The reflected signal may be or may be similar to the reflected signal 152 in FIG. 1. At step 406, the HVAC device compares the second amplitude to a baseline amplitude threshold. The baseline amplitude threshold may be or may be similar to the baseline amplitude threshold 126 in FIG. 1. At step 408, the HVAC device proceeds to step 410 when the second amplitude is less than the baseline amplitude threshold. Otherwise, the HVAC device returns to step 402 when the second amplitude is greater than the baseline amplitude threshold. At step 410, the HVAC device determines that an object is present and outputs a control signal to HVAC equipment (e.g. HVAC equipment 160 in FIG. 1) to adjust a temperature in response to the determination. The control signal may be or may be similar to the control signal 154A in FIG. 1.

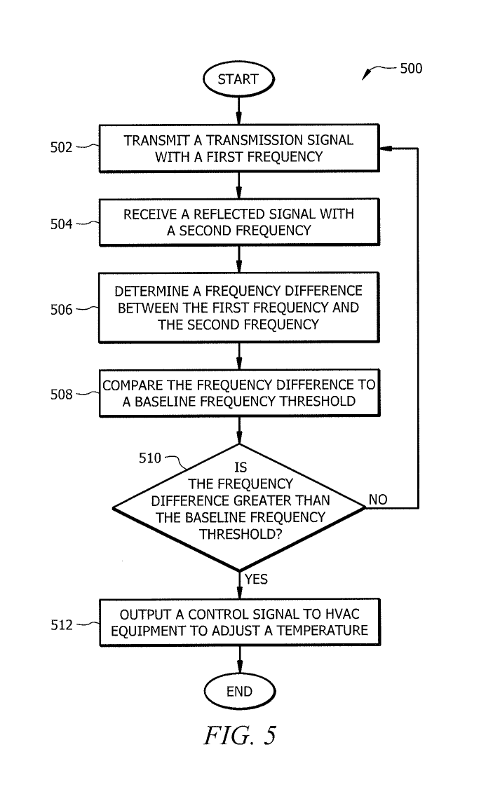

FIG. 5 is a flowchart of another embodiment of a proximity detection method 500 for an HVAC device. Method 500 is implemented by an HVAC device to determine whether an object is moving. For example, method 500 may be implemented to control the temperature in a room based on whether an object is moving within the room. The HVAC device may be configured similarly to HVAC device 100 in FIG. 1 or HVAC devices 204-208 in FIG. 2. At step 502, the HVAC device transmits a transmission signal with a first frequency. The transmission signal may be or may be similar to the transmission signal 150 in FIG. 1. At step 504, the HVAC device receives a reflected signal with a second frequency. The reflected signal may be or may be similar to the reflected signal 152 in FIG. 1. At step 506, the HVAC device determines a frequency difference between the first frequency and the second frequency. At step 508, the HVAC device compares the frequency difference to a baseline frequency threshold. The baseline frequency threshold may be or may be similar to the baseline frequency threshold 128 in FIG. 1. At step 510, the HVAC device proceeds to step 512 when the frequency difference is greater than the baseline frequency threshold. Otherwise, the HVAC device returns to step 502 when frequency difference is less than the baseline frequency threshold. At step 512, the HVAC device determines that an object moving and outputs a control signal to HVAC equipment (e.g. HVAC equipment 160 in FIG. 1) to adjust a temperature in response to the determination. The control signal may be or may be similar to the control signal 154B in FIG. 1.

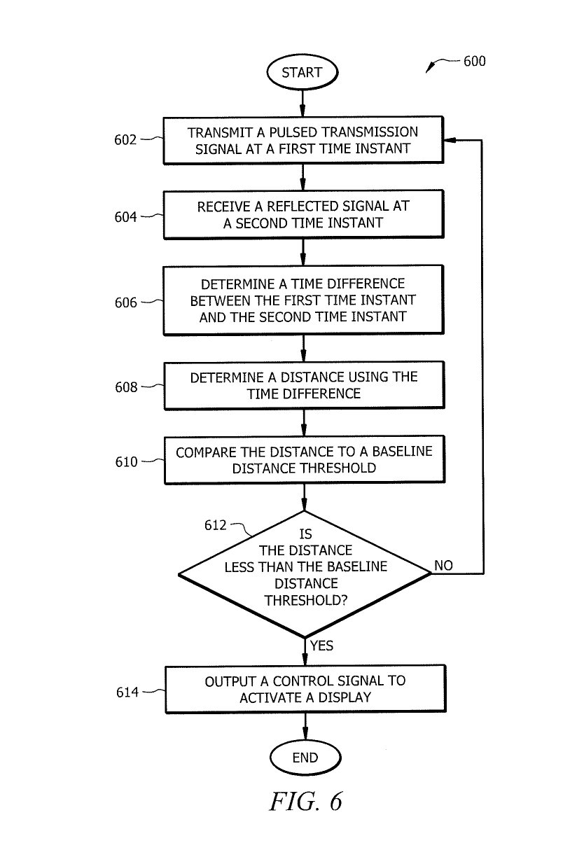

FIG. 6 is a flowchart of another embodiment of a proximity detection method 600 for an HVAC device. Method 600 is implemented by an HVAC device to determine the distance an object is away from the HVAC device. For example, method 600 may be implemented to activate a display for an HVAC device in response to determining that an object is within a predefined distance range for the HVAC device. The HVAC device may be configured similarly to HVAC device 100 in FIG. 1 or HVAC devices 204-208 in FIG. 2. At step 602, the HVAC device transmits a pulsed transmission signal at a first time instant. The pulsed transmission signal may be or may be similar to the transmission signal 150 in FIG. 1. At step 604, the HVAC device receives a reflected signal at a second time instant. The reflected signal may be or may be similar to the reflected signal 152 in FIG. 1. At step 606, the HVAC device determines a time difference between the first time instant and the second time instant. The HVAC device may determine the time difference in nanoseconds (ns), milliseconds (ms), seconds (s), or any other suitable unit of time.

At step 608, the HVAC device determines a distance between the HVAC device and the object using the time difference. For example, the HVAC device may use the time difference and the speed of the pulsed transmission signal radio wave to calculate the distance between the HVAC device and the object. Any suitable technique for calculating the distance between the HVAC device and the object using the time difference may be employed as would be appreciated by one of ordinary skill in the art upon viewing this disclosure. At step 610, the HVAC device compares the distance to a baseline distance threshold to determine whether the object is within a distance range. The baseline distance threshold may be or may be similar to the baseline distance threshold 130 in FIG. 1. At step 612, the HVAC device proceeds to step 614 when the calculated distance is less than the baseline distance threshold. Otherwise, the HVAC device returns to step 602 when the calculated distance is greater than the baseline distance threshold. At step 614, the HVAC device determines that the object is within the predetermined distance range and outputs a control signal to activate a display in response to the determination. The control signal may be or may be similar to the control signal 154C in FIG. 1. In an alternative embodiment, the HVAC device may output the control signal to HVAC equipment (e.g. HVAC equipment 160 in FIG. 1), for example, to control a temperature for a room.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. §112(f) as it exists on the date of filing hereof unless the words “means for” or “step for” are explicitly used in the particular claim.

1. A heating, ventilation, and air conditioning (HVAC) device comprising:
a transmitter configured to generate a transmission signal;
a splitter operably coupled to the transmitter, wherein the splitter is configured to:
output the transmission signal to an antenna; and
output a reflected signal to a microprocessor;
the antenna operably coupled to the splitter;
a memory operable to store at least a baseline frequency threshold for a room;
the microprocessor operably coupled to the transmitter, the splitter, the memory, and configured to:
determine a frequency difference between the frequency of the transmission signal and the frequency of the reflected signal;
compare the frequency difference to the baseline frequency threshold;
determine that an object is moving when the frequency difference is greater than the baseline frequency threshold; and
output a first control signal to adjust a temperature if the object is determined to be moving.

2. The device of claim 1, wherein:
the memory stores a baseline amplitude threshold; and
the microprocessor is configured to:
compare the amplitude of the reflected signal to the baseline amplitude threshold to determine whether the object is present; and
output the first control signal to adjust the temperature if the object is determined to be present.

3. The device of claim 2, wherein comparing the amplitude of the reflected signal to the baseline amplitude threshold determines that the object is present when the amplitude of the reflected signal is less than the baseline amplitude threshold.

4. The device of claim 2, wherein comparing the amplitude of the reflected signal to the baseline amplitude threshold comprises:
determining an amplitude difference between the amplitude of the reflected signal and the amplitude of the transmission signal; and
comparing the amplitude difference to the baseline amplitude threshold; and
determining that the object is present when the amplitude difference is greater than the baseline amplitude threshold.

5. The device of claim 1, wherein:
the transmitter is configured to generate a pulsed transmission signal; and
the microprocessor is configured to:
determine a time difference between when the pulsed transmission signal is transmitted and when the reflected signal is received;
determine a distance using the time difference;
compare the distance to a baseline distance threshold to determine whether the object is within a distance range; and
output a second control signal to activate a display if the object is determined to be within the distance range.

6. The device of claim 1, wherein the antenna is configured with a horizontal polarization to determine the objects location with respect to a horizontal plane and a vertical polarization to determine the objects location with respect to a vertical plane.

7. The device of claim 1, wherein the transmission signal is between 10 gigahertz (GHz) and 20 GHz.

8. The device of claim 1, wherein outputting the first control signal activates HVAC equipment.

9. A heating, ventilation, and air conditioning (HVAC) detection method comprising:
transmitting a transmission signal;
receiving a reflected signal in response to transmitting the transmission signal;
comparing the amplitude of the reflected signal to a baseline amplitude threshold to determine whether an object is present;
determining a frequency difference between the frequency of the transmission signal and the frequency of the reflected signal if the object is determined to be present;
comparing the frequency difference to a baseline frequency threshold;
determining that the object is moving when the frequency difference is greater than the baseline frequency threshold; and
output a first control signal to adjust a temperature if the object is determined to be moving.

10. The method of claim 9, wherein comparing the amplitude of the reflected signal to the baseline amplitude threshold determines that the object is present when the amplitude of the reflected signal is less than the baseline amplitude threshold.

11. The method of claim 9, wherein comparing the amplitude of the reflected signal to the baseline amplitude threshold comprises:
determining an amplitude difference between the amplitude of the reflected signal and the amplitude of the transmission signal; and
comparing the amplitude difference to the baseline amplitude threshold; and
determining that the object is present when the amplitude difference is greater than the baseline amplitude threshold.

12. The method of claim 9, wherein the transmission signal is a pulsed transmission signal.

13. The method of claim 12, further comprising:
determining a time difference between when the pulsed transmission signal is transmitted and when the reflected signal is received;
determining a distance using the time difference;
comparing the distance to a baseline distance threshold to determine whether the object is within a distance range; and
outputting a second control signal to activate a display if the object is determined to be within the distance range.

14. The method of claim 9, wherein the transmission signal is between 10 gigahertz (GHz) and 20 GHz.

15. A heating, ventilation, and air conditioning (HVAC) device comprising:
a transmitter configured to generate a pulsed transmission signal;
a splitter operably coupled to the transmitter, wherein the splitter is configured to:
output the pulsed transmission signal to an antenna; and
output a reflected signal to a microprocessor;
the antenna operably coupled to the splitter;
a memory operable to store at least a baseline distance threshold for a room;
the microprocessor operably coupled to the transmitter, the splitter, the memory, and configured to:
determine a time difference between when the pulsed transmission signal is transmitted and when the reflected signal is received;
determine a distance using the time difference;
compare the distance to the baseline distance threshold to determine whether an object is within a distance range; and
output a first control signal to activate a display if the object is determined to be within the distance range.

16. The device of claim 15, wherein:
the transmitter is configured to output a transmission signal;
the memory stores a baseline amplitude threshold; and
the microprocessor is configured to:
compare the amplitude of the reflected signal to the baseline amplitude threshold to determine whether the object is present; and
output a second control signal to adjust a temperature if the object is determined to be present.

17. The device of claim 16, wherein comparing the amplitude of the reflected signal to the baseline amplitude threshold determines that the object is present when the amplitude of the reflected signal is less than the baseline amplitude threshold.

18. The device of claim 16, wherein comparing the amplitude of the reflected signal to the baseline amplitude threshold comprises:
determining an amplitude difference between the amplitude of the reflected signal and the amplitude of the transmission signal; and
comparing the amplitude difference to the baseline amplitude threshold; and
determining that the object is present when the amplitude difference is greater than the baseline amplitude threshold.

19. The device of claim 16, wherein:
the transmitter is configured to output a transmission signal;
the memory stores a baseline frequency threshold; and
the microprocessor is configured to:
determine a frequency difference between the frequency of the transmission signal and the frequency of the reflected signal;
compare the frequency difference to the baseline frequency threshold;
determine that an object is moving when the frequency difference is greater than the baseline frequency threshold; and
output a second control signal to adjust a temperature if the object is determined to be moving.

20. The device of claim 16, wherein the antenna is configured with a horizontal polarization to determine the objects location with respect to a horizontal plane and a vertical polarization to determine the objects location with respect to a vertical plane.
